(19) United States
(12) Patent Application Publication
(10) Pub. No.: US 2006/0023755 A1
(43) Pub. Date: Feb. 2, 2006

(54) MPEG-TS reproduction apparatus

(76) Inventors: Hiroaki Tatsumi, Yokohama-shi (JP); Rieko Nakamura, Yokohama-shi (JP); Takayuki Miyajiri, Fujisawa-shi (JP)

Correspondence Address: FISH & RICHARDSON P.C., P.O. BOX 1022, MINNEAPOLIS, MN, 55440-1022, US

(21) Appl. No.: 11/188,998

(22) Filed: Jul. 26, 2005

(30) Foreign Application Priority Data
Jul. 30, 2004 (JP) 224695/2004

(51) Int. Cl. H04J 3/04

(52) U.S. Cl. 370/535

(57) ABSTRACT

An MPEG-TS reproduction apparatus comprises: storage means (21) for storing multiple video TSs, multiple audio TSs and at least one PSI/SI•TS (or PSI/PSIP•TS); selection means (22) for enabling selection of one video TS, one audio TS and one PSI/SI•TS (or PSI/PSIP•TS) from among the multiple TSs stored in the storage means (21); and output means (23) for reading out, via the selection means (22), one video TS, one audio TS and one PSI/SI•TS (or PSI/PSIP•TS), multiplexing the read TSs, and outputting the multiplexed TSs as a single MPEG-TS.

### BACKGROUND OF THE INVENTION

The present invention relates to an apparatus which reproduces MPEG-TS (Transport Stream), and more particularly to an apparatus which combines a video TS, audio TS and PSI/SI (Program Specification Information/Service Information) TS (or PSI/PSIP (Program System Information Protocol) TS) to reproduce them as a single MPEG-TS.

FIG. 1 (or FIG. 6) is a conceptual diagram showing an MPEG-TS recorded on conventional MPEG-TS reproduction apparatuses. As shown in FIG. 1 (or FIG. 6), a video TS 11, audio TS 12 and PSI/SI•TS 13 (or PSI/PSIP•TS 13) are preliminarily multiplexed and then recorded on a recording medium (HDD, ROM, CD, etc.) incorporated into a conventional MPEG-TS reproduction apparatus. The conventional MPEG-TS reproduction apparatuses include “MTX100” available from Tektronix, Inc. and “VT1200” available from Yokogawa Electric Corp., for example.

On a recording medium incorporated into another conventional MPEG-TS reproduction apparatus, video and audio data are recorded in a state of ES (Elementary Stream). This type of MPEG-TS reproduction apparatus converts video ES and audio ES into TS data and multiplexes them. Examples of another conventional MPEG-TS reproduction apparatus include “AD950” and “MTS300” available from Tektronix, Inc.
[Non-Patent Document 1] Internet <URL: http://www.tek.com/site/ps/0%2C%2C25-14884-INTRO_EN %2C00.html>
[Non-Patent Document 2] Internet <URL: http://www.yokogawa.com/tm/pdf/bu/vt1200/bu7065-50e_{—}010.pdf>

When multiple MPEG-TSs are reproduced, a recording medium of the conventional MPEG-TS reproduction apparatus must record preliminarily the multiple MPEG-TSs. Specifically, when multiple MPEG-TSs obtained by combining L kinds of video TS, M kinds of audio TS, and N kinds of PSI/SI•TS (or PSI/PSIP•TS) are reproduced, it is required to record a number (L×M×N) of MPEG-TSs.

When the capacity of the recording medium of the conventional MPEG-TS reproduction apparatus is small, only a part of a number (L×M×N) of MPEG-TSs is recorded. In this case, the non-recorded MPEG-TSs obtained by combining the TSs can not be reproduced.

A recording medium of another conventional MPEG-TS reproduction apparatus records video ESs and audio ESs. Specifically, when multiple MPEG-TSs obtained by combining L kinds of video TS and M kinds of audio TS are reproduced, it is sufficient to record a number (L+M) of ESs.

However, when reproduced, the ESs are converted into TS data and multiplexed. Thus, another conventional MPEG-TS reproduction apparatus can be large and expensive.

Accordingly, an object of the present invention is to reduce the capacity of a recording medium of an MPEG-TS reproduction apparatus.

Another object of the present invention is to enable reproduction of a maximum number of kinds of MPEG-TSs by use of a given capacity.

Still another object of the present invention is to provide a low-cost MPEG-TS reproduction apparatus.

The above and other objects of the present invention will become apparent to those skilled in the art by reference to the following embodiment and the accompanying drawings.

### SUMMARY OF THE INVENTION

An MPEG-TS reproduction apparatus according to the present invention includes: storage means (21) for storing multiple video TSs and multiple audio TSs; and output means (23) for reading out one video TS and one audio TS from among the multiple TSs stored in the storage means (21), multiplexing the read TSs, and outputting the multiplexed TSs as a single MPEG-TS.

The MPEG-TS reproduction apparatus can further include selection means (22) for enabling selection of one video TS and one audio TS from among the multiple TSs stored in the storage means (21). The output means (23) reads out one video TS and one audio TS via the selection means (22).

Specifically, the output means (23) includes: buffers (44, 45) for reading out, storing and outputting, on a packet by packet basis, each one of one video TS and one audio TS; and means (48, 51) for selecting either one of the video packets or audio packets outputted from the buffers (44, 45) according to a predetermined priority, and multiplexing the video packets and audio packets.

The selection means (22) includes means (41) for recording a pattern corresponding to one video TS and one audio TS.

When multiple MPEG-TSs obtained by combining L kinds of video TS, M kinds of audio TS, and N kinds of PSI/SI•TS (or PSI/PSIP•TS) are reproduced, it is sufficient for the recording medium of the MPEG-TS reproduction apparatus according to the present invention to record a number (L+M+N) of TSs. Consequently, the capacity of the recording medium of the MPEG-TS reproduction apparatus according to the present invention can be reduced compared to conventional ones.

The MPEG-TS reproduction apparatus according to the present invention stores not video ESs and audio ESs but video TSs and audio TSs. Thus, it is possible to more easily output MPEG-TSs. Consequently, it is possible to provide a low-cost MPEG-TS reproduction apparatus.

### BRIEF DESCRIPTION OF THE DRAWINGS

FIG. 1 is a conceptual diagram showing a TS recorded on conventional TS reproduction apparatuses;

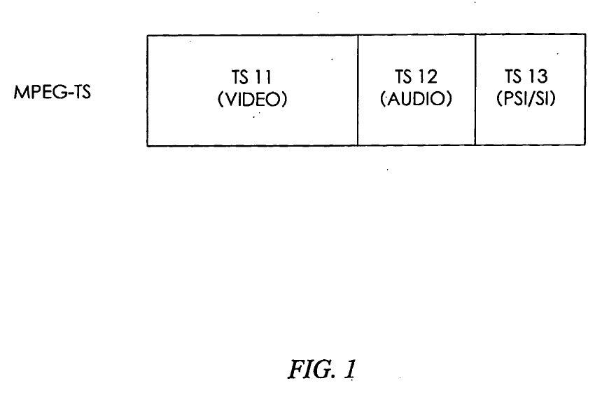

FIG. 2 is a schematic block diagram showing an MPEG-TS reproduction apparatus according to the present invention;

FIG. 3 is a chart illustrating an exemplary relationship between one video TS, one audio TS and one PSI/SI•TS, and a pattern number;

FIG. 4 is a detailed block diagram showing the MPEG-TS reproduction apparatus according to the present invention;

FIG. 5 is a diagram showing exemplary output timings of each packet of PSI/SI;

FIG. 6 is a conceptual diagram showing a TS recorded on conventional TS reproduction apparatuses;

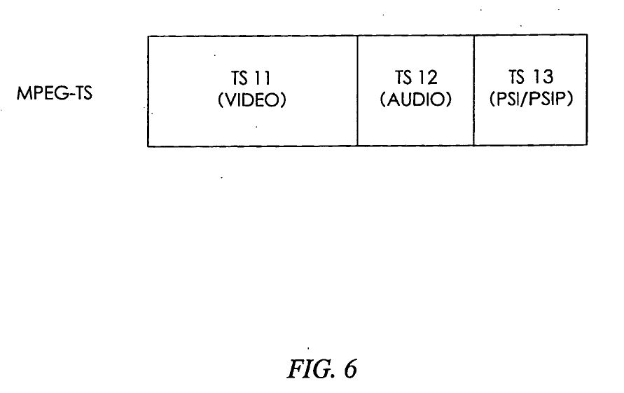

FIG. 7 is a schematic block diagram showing an MPEG-TS reproduction apparatus according to the present invention;

FIG. 8 is a chart illustrating an exemplary relationship between one video TS, one audio TS and one PSI/PSIP•TS, and a pattern number;

FIG. 9 is a detailed block diagram showing the MPEG-TS reproduction apparatus according to the present invention; and

FIG. 10 is a diagram showing exemplary output timings of each packet of PSI/PSIP.

### DETAILED DESCRIPTION OF THE INVENTION

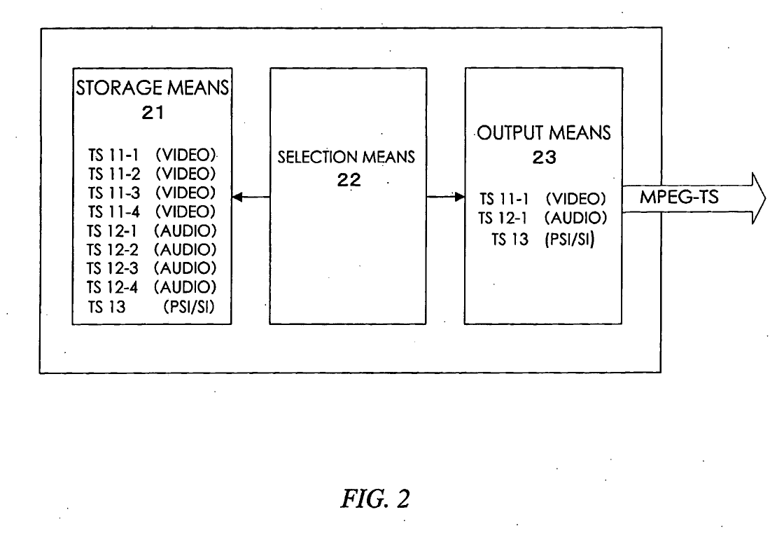

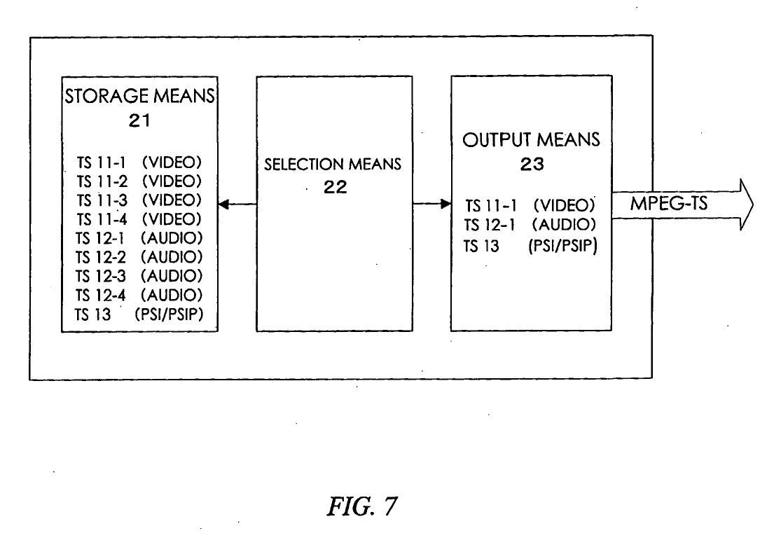

FIG. 2 (or FIG. 7) is a schematic block diagram showing an MPEG-TS reproduction apparatus according to the present invention. As shown in FIG. 2 (or FIG. 7), an MPEG-TS reproduction apparatus according to the present invention includes: storage means 21 for storing multiple video TSs, multiple audio TSs and at least one PSI/SI•TS (or PSI/PSIP•TS); selection means 22 for enabling selection of one video TS, one audio TS and one PSI/SI•TS (or PSI/PSIP•TS) from among the multiple TSs stored in the storage means 21: and output means 23 for reading out, via the selection means 22, one video TS, one audio TS and one PSI/SI•TS (or PSI/PSIP•TS), multiplexing the read TSs, and outputting the multiplexed TSs as a single MPEG-TS.

The selection means 22 records a pattern number representing the kind of MPEG-TS outputted from the output means 23. A pattern number, selected by the user, corresponds to one video TS, one audio TS and one PSI/SI•TS (or PSI/PSIP•TS) stored in the storage means 21.

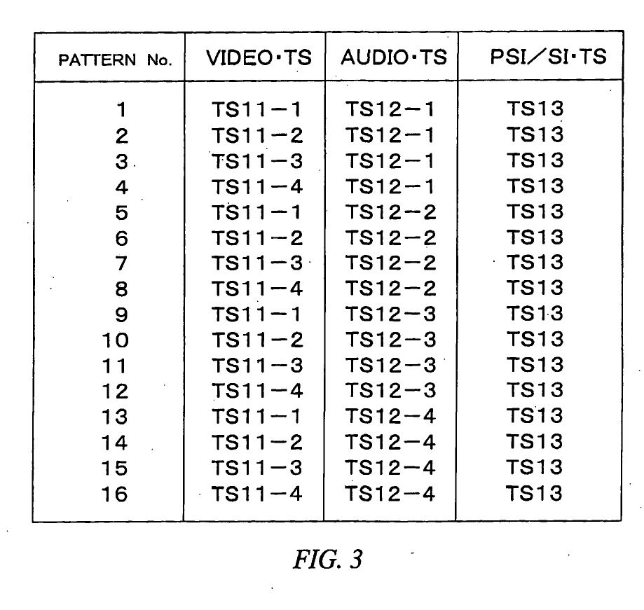

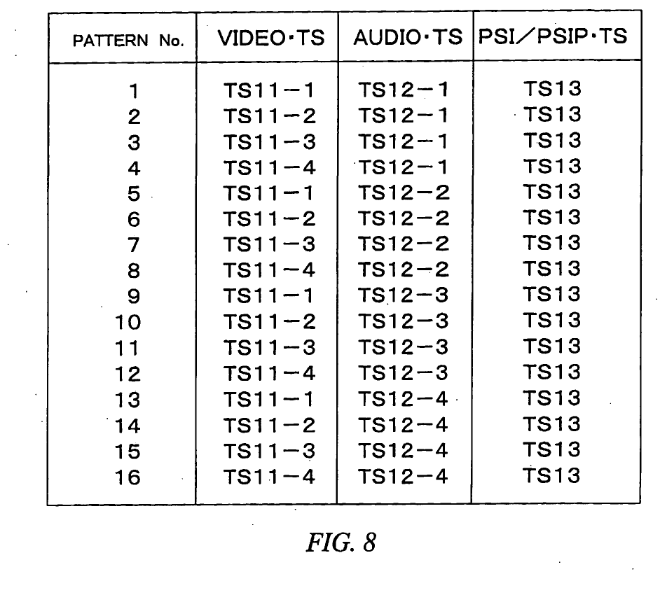

For example, suppose that four kinds of video TS (TS11-1, TS11-2, TS11-3, TS11-4), four kinds of audio TS (TS12-1, TS12-2, TS12-3, TS12-4), and one kind of PSI/SI•TS (or PSI/PSIP•TS) (TS13) are stored in the storage means 21. FIG. 3 (or FIG. 8) is a chart illustrating an exemplary relationship between a pattern number, and one video TS, one audio TS and one PSI/SI•TS (or PSI/PSIP•TS) stored in the storage means 21. Referring to FIG. 3 (or FIG. 8), pattern number 1 corresponds to the first video TS (TS11-1), the first audio TS (TS12-1), and PSI/SI•TS (or PSI/PSIP•TS) (TS13); pattern number 2 corresponds to the second video TS (TS11-2), the first audio TS (TS12-1), and PSI/SI•TS (or PSI/PSIP•TS) (TS13).

All of the multiple video TSs stored in the storage means 21 have the same packet ID. In other words, each one of the multiple video TSs stored in the storage means 21 is preliminarily generated and stored so that it has the same packet ID. Similarly, each one of the multiple audio TSs stored in the storage means 21 is preliminarily generated and stored so that it has the same packet ID.

Also, the information of the video TS and audio TS stored in the storage means 21 conforms to that of the PSI/SI•TS (or PSI/PSIP•TS) stored in the storage means 21. Specifically, the PID (packet ID) of each one of the video TS and audio TS stored in the storage means 21 correspond to the PID of each one of the video and audio data contained in PMT (Program Map Table) packet of the PSI/SI•TS (or PSI/PSIP•TS) stored in the storage means 21. Also, PCR (Program Clock Reference)-PID of the PMT stored in the storage means 21 corresponds to PID of the TS (video TS or audio TS) including the PCR. In addition, the encoding format (for example, video: MPEG-2, MPEG-4, etc, audio: MPEG-AAC, Dolby-AC3, etc.) of each one of the video and audio data in the PMT stored in the storage means 21 corresponds to that of each one of the video TS and audio TS stored in the storage means 21.

The output means 23 accesses, via the selection means 22, one video TS, one audio TS and one PSI/SI•TS (or PSI/PSIP•TS) each corresponding to one pattern number, and reads out them. Then, the output means 23 multiplexes the one video TS, one audio TS and one PSI/SI•TS (or PSI/PSIP•TS) thus read out, and outputs the multiplexed TSs as a single MPEG-TS.

After reading out one video TS and one audio TS each corresponding to one pattern number, the output means 23 rereads the one video TS and one audio TS. Consequently, the video TS and audio TS contained in the MPEG-TS outputted from the output means 23 are repeatedly reproduced.

When multiplexing one video TS, one audio TS and one PSI/SI•TS (or PSI/PSIP•TS), the output means 23 rewrites the time stamp (PCR, PTS (Presentation Time Stamp)/DTS (Decoding Time Stamp)) and continuity counter value of the MPEG-TS.

The MPEG-TS reproduction apparatus according to the present invention can store video TSs, audio TSs and PSI/SI•TSs (or PSI/PSIP•TSs). Thus, when multiple MPEG-TSs obtained by combining L kinds of video TS, M kinds of audio TS, and N kinds of PSI/SI•TS (or PSI/PSIP•TS) are reproduced, it is sufficient for the recording medium of the MPEG-TS reproduction apparatus according to the present invention to record a number (L+M+N) of TSs. Accordingly, the capacity of the recording medium of the MPEG-TS reproduction apparatus according to the present invention can be reduced compared to conventional ones.

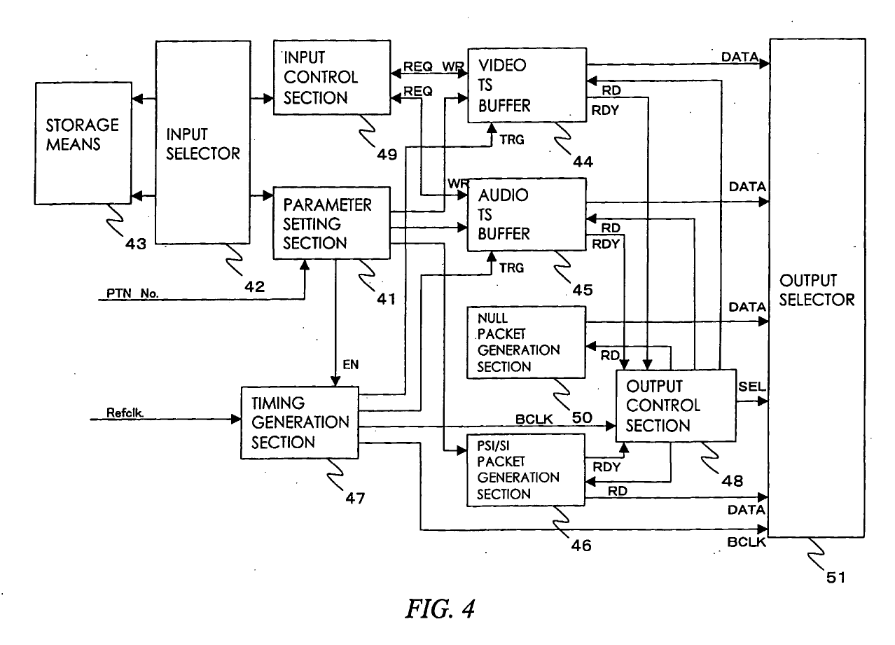

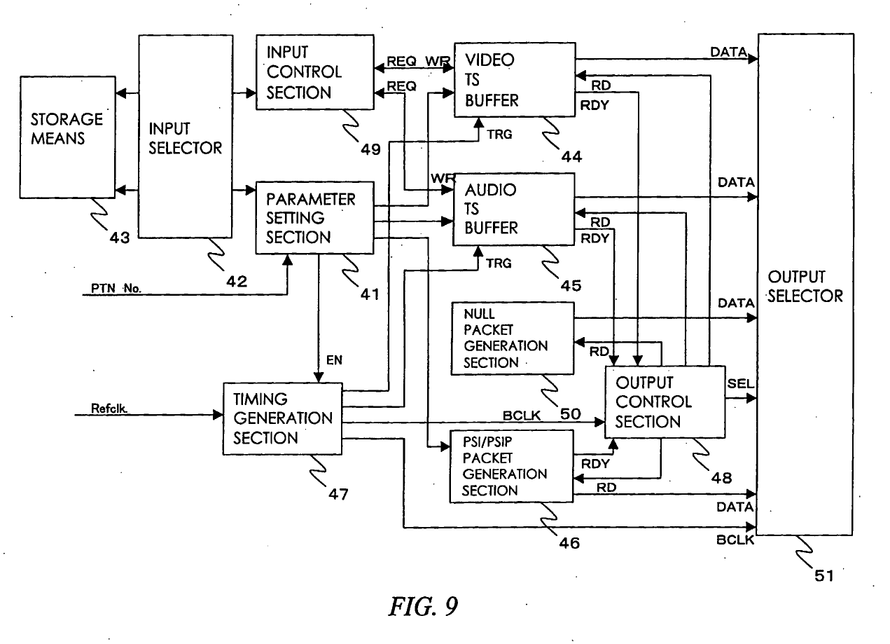

FIG. 4 (or FIG. 9) is a detailed block diagram showing the MPEG-TS reproduction apparatus according to the present invention. An operation of the MPEG-TS reproduction apparatus according to the present invention shown in FIG. 4 (or FIG. 9) will be described below.

A parameter setting section 41 receives and stores a pattern number (PTN No.) selected by the user. Also, the parameter setting section 41 stores a relationship between a pattern number, and one video TS, audio TS and PSI/SI•TS (or PSI/PSIP•TS) corresponding to the pattern number.

When receiving a pattern number (PTN No.) selected by the user, the parameter setting section 41 accesses, via an input selector 42, one video TS, one audio TS and one PSI/SI•TS (or PSI/PSIP•TS) corresponding to the pattern number stored in storage means 43 (for example, Flash-ROM having a data bus width of 16 bits). Then, the parameter setting section 41 acquires the starting address and the number of packets (one packet includes 188 bytes, for example) of each one of the one video TS and one audio TS thus assessed, and outputs the starting address and the number of packets of the video TS to a video TS buffer 44 and outputs the starting address and the number of packets of the audio TS to an audio TS buffer 45. Also, the parameter setting section 41 acquires the one PSI/SI•TS (or PSI/PSIP•TS) accessed and outputs (transfers) it to a PSI/SI (or PSI/PSIP) packet generation section 46. Also, the parameter setting section 41 acquires the data rate for each one of the one video TS and one audio TS accessed, and after transferring the PSI/SI•TS (or PSI/PSIP•TS), outputs each data rate (for example, video data rate: 8.192 Mbps, audio data rate: 0.256 Mbps) as an operation enabling signal (EN) to a timing generation section 47.

The timing generation section 47 receives a reference clock (Refclk, 12.288 MHz, for example). The timing generation section 47 divides the reference clock according to the operation enabling signal (EN) from the parameter setting section 41 to generate reading clocks (for example, video reading clock: 1.024 MHz, audio reading clock: 0.032 MHz) corresponding to the respective data rates of the video TS and audio TS. The timing generation section 47 divides each one of the reading clocks by 188 to generate a read trigger signal corresponding to one packet period. Then, the timing generation section 47 outputs the read trigger signal (TRG) for video to the video TS buffer 44, and outputs the read trigger signal (TRG) for audio to the audio TS buffer 45. Also, the timing generation section 47 divides the reference clock to generate a TS output clock corresponding to the output data rate (12.288 MHz, for example) of the MPEG-TS reproduction apparatus, and output the TS output clock (BCLK) to an output control section 48 and an output selector 51.

The video TS buffer 44 receives from the parameter setting section 41 the starting address and the number of packets of the one video TS corresponding to the pattern number. The video TS buffer 44 stores the starting address as an address value. Also, the video TS buffer 44 receives from the timing generation section 47 the read trigger signal corresponding to one packet period of the video TS. According to the read trigger signal for video, the video TS buffer 44 outputs the address value as a read request signal (REQ) to an input control section 49.

Similarly, the audio TS buffer 45 receives from the parameter setting section 41 the starting address and the number of packets of the one audio TS corresponding to the pattern number. The audio TS buffer 45 stores the starting address as an address value. Also, the audio TS buffer 45 receives from the timing generation section 47 the read trigger signal corresponding to one packet period of the audio TS. According to the read trigger signal for audio, the audio TS buffer 45 outputs the address value as a read request signal (REQ) to an input control section 49.

According to the read request signal (REQ) for video and the read request signal (REQ) for audio, the input control section 49 generates from the specified address value a control signal (CTRL) for reading out data corresponding to a width of 94 words (188 bytes=one packet), and reads out, via the input selector 42, one packet of each one of the one video TS and one audio TS corresponding to the pattern number from the storage means 43. The input control section 49 outputs the one video packet thus read to the video TS buffer 44, and outputs the one audio packet thus read to the audio TS buffer 45. After completion of reading the one video packet and one audio packet, the input control section 49 outputs a completion signal (UP) to the video TS buffer 44 and audio TS buffer 45.

More specifically, whenever reading one-byte data from among one packet of each one of one video TS and one audio TS, the input control section 49 outputs a write trigger signal (WR) for each one-byte data to the video TS buffer 44 and audio TS buffer 45.

Whenever receiving the write trigger signal (WR) from the input control section 49, each one of the video TS buffer 44 and audio TS buffer 45 holds the read data, separates the data as one-byte data, and writes the data into the respective FIFOs of the video TS buffer 44 and audio TS buffer 45. It is noted that when the starting one-byte data of each packet is written, a Packet Synchronization flag (PSYNC) is also written into the FIFO. When the remaining amount of data in the FIFO reaches at least one packet, each one of the video TS buffer 44 and audio TS buffer 45 outputs a read ready signal (RDY) to the output control section 48.

Whenever receiving a completion signal (UP) from the input control section 49, each one of the video TS buffer 44 and audio TS buffer 45 adds to the current address value an address value (+94 words or +188 bytes) corresponding to one packet to update the address value. Each of the video TS buffer 44 and audio TS buffer 45 counts completion signals (UP); when the count value corresponds with the number of packets, the address value is reset to the starting address, and at the same time the count value is initialized.

The PSI/SI (or PSI/PSIP) packet generation section 46 receives, via the input selector 42, one PSI/SI•TS (or PSI/PSIP•TS) being stored in the storage means 43 from the parameter setting section 41. The one PSI/SI•TS (PSI/PSIP•TS) being stored in the storage means 43 includes PAT (Program Association Table) packet, PMT (Program Map Table) packet and NIT (Network Information Table) packet (or PAT packet, PMT packet, MGT (Master Guide Table) packet and VCT (Virtual Channel Table) packet). The PSI/SI (or PSI/PSIP) packet generation section 46 stores the one PSI/SI•TS (or PSI/PSIP•TS) thus received (PAT packet, PMT packet and NIT packet (or PAT packet, PMT packet, MGT packet and VCT packet)), for example into a buffer RAM of the PSI/SI (or PSI/PSIP) packet generation section 46.

TOT (Time Offset Table) (or STT (System Time Table)) contained in PSI/SI (or PSI/PSIP) includes specification of the current date and time. Thus, TOT (or STT) packet is generated by the PSI/SI (or PSI/PSIP) packet generation section 46. Instead of TOT packet, TDT (Time and Date Table) may be generated.

The PSI/SI (or PSI/PSIP) packet generation section 46 generates output timings for each one of PAT packet, PMT packet, NIT packet and TOT packet (or PAT packet, PMT packet, MGT packet, VCT packet and STT packet). Specifically, the output intervals of the PAT packet, PMT packet, NIT packet and TOT packet (or PAT packet, PMT packet, MGT packet, VCT packet and STT packet) are 100 msec, 100 msec, 1 sec and 5 sec (or 100 msec, 400 msec, 100 msec, 400 msec and 1 sec), respectively, for example. The PSI/SI (or PSI/PSIP) packet generation section 46 outputs read ready signals (RDY) for each one of PAT packet, PMT packet, NIT packet and TOT packet (or PAT packet, PMT packet, MGT packet, VCT packet and STT packet) to the output control section 48 at the output timings of each packet.

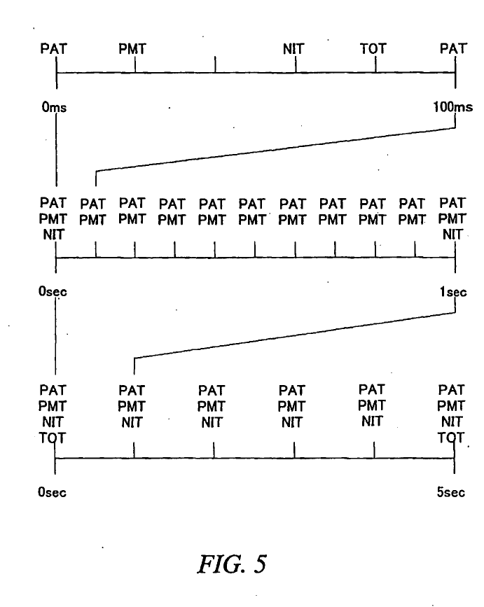

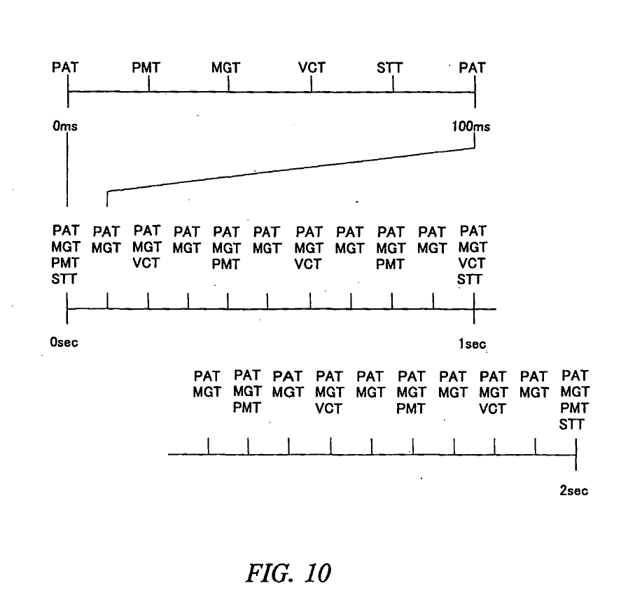

FIG. 5 (or FIG. 10) is a diagram showing exemplary output timings of each packet of PSI/SI (or PSI/PSIP). As shown in FIG. 5 (or FIG. 10), the output timings of each one of PAT packet, PMT packet, NIT packet and TOT packet (or PAT packet, PMT packet, MGT packet, VCT packet and STT packet) are preferably set so that they do not overlap with each other. Referring to the example of FIG. 5 (or FIG. 10), the output timing of PMT packet is delayed 20 msec relative to that of PAT packet (0 msec: reference timing). (The output timing of MGT packet is delayed 40 msec relative to that of PAT packet (0 msec: reference timing).) The output timing of NIT (or VCT) packet is delayed 60 msec relative to that of PAT packet (0 msec: reference timing). The output timing of TOT (or STT) packet is delayed 80 msec relative to that of PAT packet (0 msec: reference timing). By employing such combination of output timings, adverse effects (jitter) on timestamps of each one of video TS and audio TS can be lessened, and at the same time, the required amount of the video TS buffer 44 and audio TS buffer 45 can be reduced to about several packets.

Referring back to FIG. 4 (or FIG. 9), the output control section 48 monitors read ready signals (RDY) from each one of the video TS buffer 44, audio TS buffer 45 and PSI/SI (or PSI/PSIP) packet generation section 46 according to TS output clock (BCLK) corresponding to the output data rate (12.288 MHz, for example) of the output selector 51 (MPEG-TS reproduction apparatus).

When the read ready signal (RDY) is on, the output control section 48 outputs a read request signal (RD) to any one of the video TS buffer 44, audio TS buffer 45 and PSI/SI (PSI/PSIP) packet generation section 46 corresponding to the read ready signal (RDY). When plural read ready signals (RDY) are on, the output control section 48 outputs one read request signal (RD) according to a predetermined priority. For example, the predetermined priority is such that the first priority is TOT packet, the second priority is NIT packet, the third priority is PMT packet, the fourth priority is PAT packet, the fifth priority is audio packet, and the sixth priority is video packet (or the first priority is STT packet, the second priority is VCT packet, the third priority is PMT packet, the fourth priority is MGT packet, the fifth priority is PAT packet, the sixth priority is audio packet, and the seventh priority is video packet).

When the read ready signal (RDY) is off, the output control section 48 outputs a read request signal (RD) to a NULL packet generation section 50.

The output control section 48 outputs a read request signal (RD) to any one of the video TS buffer 44, audio TS buffer 45, PSI/SI (or PSI/SI) packet generation section 46 and NULL packet generation section 50, and at the same time, outputs to the output selector 51 a selection signal (SEL) enabling selection of any one signal from the corresponding devices 44, 45, 46 and 50.

When receiving a read request signal (RD) from the output control section 48, each one of the video TS buffer 44 and audio TS buffer 45 reads out, on a byte by byte basis, the data stored in the respective FIFOs, and outputs the read data to the output selector 51. At the time when 188 bytes of data are read out from the respective FIFOs, each one of the video TS buffer 44 and audio TS buffer 45 outputs a one-packet read completion signal to the output control section 48.

When receiving a read request signal (RD) for PAT packet, PMT packet or NIT packet (or PAT packet. PMT packet MGT packet or VCT packet) from the output control section 48, the PSI/SI (or PSI/PSIP) packet generation section 46 reads out PAT packet, PMT packet or NIT packet (or PAT packet, PMT packet MGT packet or VCT packet) recorded on the buffer RAM of the PSI/SI (or PSI/PSIP) packet generation section 46, and outputs the read data to the output selector 51. When receiving a read request signal (RD) for TOT (or STT) packet, the PSI/SI (or PSI/PSIP) packet generation section 46 generates current data and time information, applies a CRC (Cyclic Redundancy Check) processing to the information to create a TOT (or STT) packet (or TDT packet), and records the created packet onto the buffer RAM. Then, the PSI/SI (or PSI/PSIP) packet generation section 46 reads out the TOT (or STT) packet from the buffer RAM and outputs the data to the output selector 51. At the time when each packet is read out from the buffer RAM, the PSI/SI (or PSI/PSIP) packet generation section 46 outputs a one-packet read completion signal to the output control section 48.

The output selector 51 receives a selection signal (SEL) from he output control section 48. According to the selection signal (SEL), the output selector 51 selects one packet from any one of the video TS buffer 44, audio TS buffer 45, PSI/SI (or PSI/PSIP) packet generation section 46 and NULL packet generation section 50. The output selector 51 outputs the selected packet as an MPEG-TS according to the TS output clock (BCLK) corresponding to the output data rate (12.288 MHz, for example) of the MPEG-TS reproduction apparatus.

When outputting the selected packet as an MPEG-TS, the output selector 51 rewrites the time stamp (PCR and PTS/DTS) and continuity counter value of the MPEG-TS.

The storage means 43 (Flash-ROM, for example) stores multiple video TSs, multiple audio TSs, and at least one PSI/SI•TS (or PSI/PSIP•TS). One video TS, one audio TS and one PSI/SI•TS (or PSI/PSIP•TS) corresponding to one pattern number are multiplexed by the output selector 51 and outputted from the output selector 51. All of the multiple video TSs stored in the storage means 43 have the same packet ID so that when another selection number is selected by the user, each component TS of an MPEG-TS outputted from the output selector 51 is replaced. In other words, each one of the multiple video TSs of the storage means 43 is preliminarily generated for storage so that it has the same packet ID. Similarly, each one of the multiple audio TSs of the storage means 43 is preliminarily generated for storage so that it has the same packet ID. Also, the information of video TSs and audio TSs stored in the storage means 43 matches with the information of PSI/SI•TSs (or PSI/PSIP•TSs) stored in the storage means 43.

As described above, each one of the video TS buffer 44 and audio TS buffer 45 counts completion signals (UP). When the count value corresponds to the number of packets, the address value is reset to the starting address, and at the same time, the count value is initialized. Accordingly, each one of the video TS and audio TS of the MPEG-TS outputted from the output selector 51 is repeatedly reproduced.

The data amount of the video TS and audio TS recorded on the storage means 43 is preliminarily generated as an integer multiple of each frame rate (for example, video frame rate: (1001/30000) sec, audio frame rate: (1024/480000) sec). In a video TS and audio TS recorded on the storage means 43, there is contained a test signal TS (for example, video TS: color bar, audio TS: 1 kHz). When the audio TS recorded on the storage means 43 is a periodic audio signal, the data amount of the audio TS recorded on the storage means 43 is an integer multiple of the least common multiple ((3072/480000) sec, for example) between an audio frame rate ((1024/480000) sec) and an audio signal period (for example, ((48000/1000)/480000) sec=(48/48000) sec. when the audio signal is a sinusoidal wave of 1 kHz, and the sampling frequency of the audio frame rate is 48000 Hz). Accordingly, when the audio TS of MPEG-TS is repeatedly reproduced, the audio continuity can be maintained.

What is claimed is:

1. An MPEG-TS reproduction apparatus comprising:
storage means (21) for storing a plurality of video TSs and a plurality of audio TSs; and
output means (23) for reading out one video TS and one audio TS from among the plurality of TSs stored in the storage means (21), multiplexing the read TSs, and outputting the multiplexed TSs as a single MPEG-TS.

2. The MPEG-TS reproduction apparatus according to claim 1, further comprising selection means (22) for enabling selection of one video TS and one audio TS from among the plurality of TSs stored in the storage means (21), wherein the output means (23) reads out one video TS and one audio TS via the selection means (22).

3. The MPEG-TS reproduction apparatus according to claim 2, wherein:
the storage means (21) further stores at least one PSI/SI•TS;
the selection means (22) further enables selection of one PSI/SI•TS; and
the output means (23) further reads out and multiplexes one PSI/SI•TS.

4. The MPEG-TS reproduction apparatus according to claim 1, wherein the output means (23) includes:
buffers (44, 45) for reading out, storing and outputting, on a packet by packet basis, each one of one video TS and one audio TS; and
means (48, 51) for selecting either one of the video packets or audio packets outputted from the buffers (44, 45) according to a predetermined priority, and multiplexing the video packets and audio packets.

5. The MPEG-TS reproduction apparatus according to claim 2, wherein the selection means (22) includes means (41) for recording a pattern corresponding to one video TS and one audio TS.

6. The MPEG-TS reproduction apparatus according to claim 3, wherein the output means (23) includes:
buffers (44, 45, 46) for reading out, storing and outputting, on a packet by packet basis, each one of one video TS, one audio TS and one PSI/SI•TS; and
means (48, 51) for selecting either one of the video packets, audio packets and PSI/SI packets outputted from the buffers (44, 45, 46) according to a predetermined priority, and multiplexing the video packets, audio packets and PSI/SI packets; and
wherein the selection means (22) includes means (41) for recording a pattern corresponding to one video TS, one audio TS and one PSI/SI•TS.

7. The MPEG-TS reproduction apparatus according to claim 2, wherein:
the storage means (21) further stores at least one PSI/PSIP•TS;
the selection means (22) further enables selection of one PSI/PSIP•TS; and
the output means (23) further reads out and multiplexes one PSI/PSIP•TS.

8. The MPEG-TS reproduction apparatus according to claim 7, wherein the output means (23) includes:
buffers (44, 45, 46) for reading out, storing and outputting, on a packet by packet basis, each one of one video TS, one audio TS and one PSI/PSIP•TS; and
means (48, 51) for selecting either one of the video packets, audio packets and PSI/PSIP packets outputted from the buffers (44, 45, 46) according to a predetermined priority, and multiplexing the video packets, audio packets and PSI/PSIP packets; and
wherein the selection means (22) includes means (41) for recording a pattern corresponding to one video TS, one audio TS and one PSI/PSIP•TS.
